(19) United States
(12) Patent Application Publication
(10) Pub. No.: US 2025/0139550 A1
(43) Pub. Date: May 1, 2025

(54) AUTONOMOUS MECHANISM FOR TRACKING EXECUTION PATHS IN DYNAMIC SYSTEMS

(71) Applicant: ORACLE INTERNATIONAL CORPORATION, Redwood Shores, CA (US)

(72) Inventors: Anadi UPADHYAYA, San Ramon, CA (US); Krishnaraj MAHADEVAN, Hyderabad (IN)

(21) Appl. No.: 18/384,462

(22) Filed: Oct. 27, 2023

(51) Int. Cl. G06Q 10/0631

(52) U.S. Cl. CPC G06Q 10/06316

(57) ABSTRACT

Systems, methods, and other embodiments associated with tracking execution paths in dynamic systems are described. In one embodiment, a method includes, for a first set of input values, executing a first execution of dynamic functions to generate a first final result, wherein calculation attributes have a first set of values during run-time. In response to a change, re-executing the dynamic functions to generate a second final result in a second execution. During the second execution, track the dynamic functions that were executed and determine an execution path during the second execution. The method determines, from the functions that were executed, how calculation expressions are calculated during the second execution. The execution path is visually displayed that visually shows a sequence of executed dynamic functions and/or a summary of tracking results to visually identify attribute value changes between the first execution and the second execution.

### BACKGROUND

Software applications have become an integral part of our daily lives, from mobile applications that provide navigation directions to complex financial modeling software used in business and finance. These applications often employ complex algorithms to process data and provide valuable functionalities to users. However, a common issue with such software is the lack of transparency regarding how these algorithms work, especially when they involve multiple functions and intricate calculations. This opacity can lead to user frustration, a lack of trust in the software, and the potential for users to make decisions based on inaccurate or misunderstood information.

Users typically interact with these applications through user interfaces that hide the underlying calculations, making their algorithms inaccessible and often incomprehensible to the end user. Previous software applications use various approaches to address these issues. Some offer limited “help” or “about” sections that provide brief overviews of the algorithms, but these are too high-level and do not delve into the specifics of calculation methods. In many cases, users are left to interpret results without clear explanations, and this problem persists across various domains, from machine learning models to financial software.

Another problem that exists in many software systems is that it is difficult to identify which related data, calculations, or processing functions contributed to a final output response. These software systems are built with many complex programmed functions that execute internally in hidden and non-transparent code. As such, the system simply outputs a result based on some input without providing internal information to identify which related data, calculations, or processing functions contributed to the response.

For an administrator, manager, or end user, it is frustrating to receive an error or an unexpected response from a software system without any context or information as to how the unexpected response or error was reached. Even more problematic is when the software outputs an incorrect response without an error. This gives the user a false sense that data, conditions, and/or calculations that were processed are correct and functioning properly.

### SUMMARY

In one embodiment, a computer-implemented method is described that includes inputting, into a memory of a computing device, a plurality of dynamic functions that are configured to sequentially execute, each dynamic function of the plurality of dynamic functions being interdependent on at least one other dynamic function based on a plurality of calculation attributes; wherein one or more of the dynamic functions have at least one or more calculation expressions and one or more conditional expressions, the calculation expressions and conditional expressions being dependent on one or more of the plurality of calculation attributes from other dynamic functions. For a first set of input values, executing a first execution of the plurality of dynamic functions to generate a first final result, wherein the plurality of calculation attributes has a first set of calculation attribute values during run-time. The method may track and determine how expressions are calculated during the first execution as described herein.

A second execution run may then be performed that re-executes the plurality of dynamic functions to generate a second final result. The second execution run may be performed in response to a user, via a graphical user interface (GUI), changing one calculation attribute value from the first set of input values to a second value and re-executing, or may be in response to a programming change of the calculation system (e.g., a function or calculation expression being modified or reconfigured). The reason for re-execution does not affect the functioning of the present system as there may be other reasons for re-execution. During the second execution, tracking the plurality of dynamic functions that were executed for generating the second final result and generating an execution path of functions that were executed during the second execution. The tracking method determines, from the functions that were executed, how one or more calculation expressions are calculated during the second execution and identifying a second set of calculation attribute values of the calculated expressions that occurred during the second execution. Triggered conditional expressions are identified, which include conditional expressions from the dynamic functions that were triggered during the second execution, wherein the triggered conditional expressions are included in the execution path. On the GUI, the execution path may be displayed that visually shows a progression of how the changed calculation attribute caused subsequent changes in results at subsequently executed dynamic functions in the plurality of dynamic functions. A summary of tracking results may be generated and displayed to visually identify attribute value changes between the first execution and the second execution, wherein the summary of tracking includes the first set of calculation attribute values that occurred during the first execution and the second set of calculation attribute values that occurred during the second execution.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a computing system configured to provide an autonomous dynamic execution tracking system for tracking execution paths in dynamic systems.

FIG. 2 illustrates one embodiment of a method performed by the system of FIG. 1 for tracking an execution path of multiple interdependent functions.

FIG. 3 illustrates one embodiment of an overview of a run-time or operational method associated with the autonomous dynamic execution tracking system of FIG. 1 triggered by an input causing a change in an attribute value.

FIGS. 4-6 illustrate one embodiment of sub-steps associated with FIG. 3.

FIG. 7 illustrates one embodiment of a visual display of a collection of attribute values and properties from a first execution run (previous values or states) and a second execution run that are tracked and shows a summary of data value changes between each execution run.

FIG. 8 illustrates another embodiment of visually displaying a summary of tracking results from FIG. 7 between a first execution run and a second execution run from the tracking system.

FIG. 9A illustrates one embodiment of visually displaying execution trail details that were tracked from a function/attribute from FIG. 8 that includes calculation and/or conditional expressions.

FIGS. 9B-9C illustrates one embodiment of visually displaying execution trail details for other functions/attributes from FIG. 8.

FIG. 9D illustrates one embodiment of visually displaying execution trail details of an executed alert(s) that occurred in processing a dynamic function and its corresponding calculation and/or conditional expressions.

FIG. 10 illustrates an embodiment of a computing system configured with the example systems and/or methods disclosed.

### DETAILED DESCRIPTION

Systems and methods described herein are associated with a computer-implemented autonomous system for tracking execution paths and states of dynamic calculations of a calculation system between multiple execution runs. The tracking system is configured to identify dynamic calculation paths taken in a dynamic calculation system, in one embodiment. The autonomous dynamic execution tracking system enables identification, tracking, and management of complex calculation systems that route multiple data values for processing in a large array of dynamic functions that process data values passed from other dynamic functions that are operating together.

The present execution tracking system provides a unique and innovative approach that can be applied to a wide range of software domains, from complex compensation algorithms to healthcare applications that employ intricate medical algorithms to predictive maintenance software used in industrial settings.

In one embodiment, the present execution tracking system provides improvements and advantages to calculation algorithms/systems that execute based on one or more input values and output a final result. These calculation systems are configured to simply output the final result without showing which functions were executed and without showing intermediate results that led to the final result. In one embodiment, present execution tracking system provides graphical visual details that may expose such hidden execution details.

Thus, the present execution tracking system may be configured to, for example, track which functions executed in the system based on a set of input values, what data variables were involved, and what data values the variables had at each executed function. In one embodiment, when one or more data values are changed and the dynamic functions are re-executed, the present tracking system can provide visual information about state changes between both execution runs, for example, as before-and-after snap shots of the dynamic functions and data values. This provides visual access into the previously hidden execution path of a calculation system that is an improvement over previous software tracking systems that do not provide behind-the-scenes execution paths or data value results.

With the present system, in one embodiment, an improvement is provided where the accuracy of calculation system itself may be verified including whether the executed functions are configured correctly. This was not possible in previous systems that only gave a final result as output. The present system is also an improvement over systems that do not provide execution trails between two or more execution runs based on different input data. The present execution tracking system provides multiple run-time execution paths, which helps to verify accuracy of generated data values and verify if the executed functions are configured correctly.

In one embodiment, the present execution tracking system may display visually how data values and results were calculated when an input value is changed, and which interdependent dynamic functions were executed to process the data values. By identifying and displaying visually how other dynamic functions are executed and processed given a data value change, the autonomous dynamic execution tracking system can piece together an execution trail and each data value change resulting from each dynamic function that is executed (which provides an intermediate result) along the execution trail to a final result. The autonomous dynamic execution tracking system can identify the execution paths taken by a dynamic calculation system without human intervention that would require mapping potential ways on how a data value change would be processed in a dynamic calculation system.

In one embodiment, a dynamic calculation system as discussed herein includes, but is not limited to, a computer application/program that includes one or more algorithms configured to generate one or more results based on one or more input values. The algorithm comprises a set of interdependent functions. The interdependent functions include, for example, a set of functions that execute sequentially in the algorithm and each function generates an output (e.g., intermediate results) that serves as an input to a subsequent function until the end final result is determined. However, based on the output of a function or a condition that may be triggered during the execution, the execution path of the algorithm may change causing a different subset of the interdependent functions to execute. This is problematic for tracking execution as previously described.

One example of a calculation system may be a compensation calculation system that calculates a compensation value based on a set of input values, which will be described later. Another example may be a forecasting algorithm that makes predictions about some subject matter based on a set of input assumptions. In general, any algorithm that includes a plurality of functions that operate together may be considered a calculation system whose execution may be tracked by the present execution tracker system.

In one embodiment, the present dynamic execution tracking system can be configured to process, identify, track, and help manage a complex calculation system by tracking data value changes and functions executed between two different execution runs or multiple execution runs. Further, the autonomous dynamic execution tracking system may be configured to display calculation expressions and/or conditional expressions that are configured within each interdependent function to provide context of what was executed. For example, the context may include details such as a source of a function call request, the prior data value (from a first execution) and the updated data value (from a second execution), and the order of execution for processing an inputted data value change.

In another embodiment, the displayed tracking information may be further configured to provide a summary of data value changes between two execution runs. The displayed execution tracking information may also provide a readable description of what functions were executed, the order of executed functions, what data was processed by the functions, and/or what alert conditions were trigger and the data values that caused the alert. The visual description may also show how subsequently executed dynamic functions processed a data value change and how the data value change impacted other data values and calculation functions.

For example, the autonomous dynamic execution tracking system may be used to determine: how an error code in a flight or vehicle test system was reached, how a tax preparation software arrived at an unexpected result given a user provided data value, how accounting software data discrepancies originated or were progressed through a global and complex calculation setup, how an insurance quote was generated and whether the data values used and functions processed is stale, and how an employee's salary, compensation, or benefits were calculated in an organization's compensation system, or other desired process.

In one embodiment, the complexity of data and data processing functions may be illustrated using a compensation system that includes thousands of employees with each employee having many attributes that contribute to determining their compensation at a company or organization. Although the attributes values may be entered and stored on a compensation system, their value may depend on other attribute values, any number of which may change over time. These changing conditions cause the compensation system to include policies defined by the organization for determining custom rules and calculations that dynamically determine an employee's salary, compensation, and benefits. To allocate compensation for employees, organizations often use software solutions for managing the data of their workforce and managers use this employee data to make compensation decisions. A manager may make compensation decisions based on dynamic employee data such as performance rating, rank, prior compensation, current salary, salary ranges, market benchmarking data, years in service, travel expenses, being in different countries, currencies, job roles, projects completed, and other dynamic data points.

There are numerous dynamic data points which can be used in compensation decisions, and consequently, there are numerous dynamic functions that take these dynamic data points to calculate employee compensation. While every organization has its own compensation policies with employee data values defined by the organization based on rules or custom calculations and other related available data of employees. In the above dynamic calculation systems as well as the compensation system described herein, calculations and conditional expressions are often dynamic, where one data value change may trigger several interdependent calculations and data values to change in subsequent calculations.

In some embodiments, the data values can also be used to define alert conditions that are triggered based on certain data value conditions. For example, some examples of alerts in a compensation system triggered by dynamic calculations include an alert when employee performance is low, but the manager entered a high bonus amount, an alert when a terminated employee is allocated a compensation amount.

Many types of dynamic calculation setups and scenarios within a dynamic calculation system may be contemplated per industry, application, organization, or company. In some embodiments, dynamic calculation setups have complex conditions and formulae that may trigger multiple other dynamic calculations upon a data value change. Further, dynamic calculations may happen in a certain order, with one data value being calculated first before another based on a pre-defined or user-defined order of precedence. Moreover, dynamic calculations rely on data values that are set with custom calculation rules that may have hundreds of conditions with varying outcomes that impact a final result. The present execution tracking system may be implemented to track and expose these types of execution details to identify how data values changed and how data values were calculated.

### System Embodiment

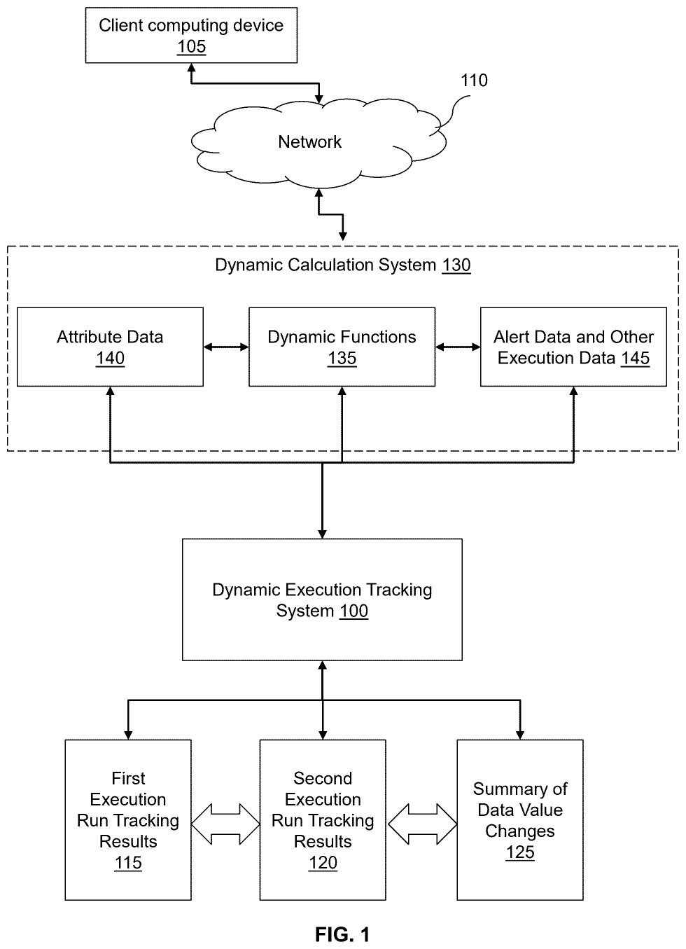

With reference to FIG. 1, one embodiment of a computing environment is illustrated that is configured with a dynamic execution tracking system 100. In one embodiment, the dynamic execution tracking system 100 is configured to autonomously execute with and/or be integrated with a selected software application that includes a dynamic calculation system 130. In one embodiment, the execution tracking system 100 is configured to track and generate an execution trail of the dynamic calculation system 130 in a visual manner after execution and after multiple execution runs when a data value is changed.

The generated execution trail allows a user to easily diagnose calculation setup issues to easily understand the calculation logic of the calculation system 130 by following the execution trail visually. In one embodiment, two or more execution trails may be displayed from two or more different execution runs. This provides a visual display of how a change in one or more input values impacts a final result between execution runs.

As previously described, in one embodiment, the dynamic calculation system 130 may include, but is not limited to, a computer application/program that includes one or more algorithms configured to generate one or more results based on one or more input values. The algorithm comprises a set of interdependent functions that generate a result based on attributes/variables and calculation logic. The interdependent functions may include, for example, a set of functions that execute sequentially in the algorithm and each function generates an output (e.g., an intermediate result(s)) that serves as an input to a subsequent function until the end result is generated. Depending on certain run-time data values of attributes/variables, the algorithm may execute different sub-sets of the functions (e.g., a different execution path) based on conditional logic and/or conditional expressions in the algorithm.

In one embodiment, the execution tracking system 100 may be configured with interprocess communication (IPC) mechanisms with the application containing the calculation system 130. IPC methods include message passing, shared memory, and remote procedure calls. Thus, the execution tracking system 100 may track and obtain properties and formulas of functions, conditional expressions, and attribute values during execution.

In another embodiment, application of the calculation system 130 may be designed to provide access to certain information and/or functionality by exposing an Application Programming Interface (API) or offering a plugin system that allows the execution tracking system 100 to interact with the calculation system for tracking execution trail data. This is a structured and secure way to access data and formulas.

In another embodiment, the execution tracking system 100 may include tracking code and data extraction features implemented into the code of the calculation system 130 to collect data and formulas from the calculation system 130 during execution. The implementation embodiments are not intended to be limiting.

As shown in FIG. 1, the computing environment (e.g., a cloud-computing environment) may provide access to remote client devices such as client computing device 105 through one or more network communication channels 110 (e.g., a communication bus, wireless communication, wired networks, combinations of channels, etc.). A client device may access and communicate with the dynamic execution tracking system 100 via a graphical user interface to run data values through the dynamic calculation system 130. The execution tracking system 100 is configured to track, trace, and identify an execution trail taken by the dynamic calculation system 130 and visually display how data value changes impact and progress through the dynamic calculation system 130 from one execution run (with a first set of input values) to another execution run (with one or more different input values).

For example, when the dynamic calculation system 130 is executed with a first set of input values, the execution tracking system 100 may track and trace what functions were executed, the order of executed functions, the calculation expressions used by each function, what data attributes were used in the functions and their data values, and/or what alert conditions were triggered and the data values that caused the alert. First tracking results 115 for the first execution run may be stored in a log or other data structure. The first execution run and its tracking results may be assigned an execution identifier (ID), which may be used to identify the data used during execution (e.g., for a specific employee or other conditions). When a change is made and the calculation system 130 is re-executed (e.g., second execution run), the execution tracking system 100 again tracks and traces the execution to generate second tracking results 120 from the second execution run. The second execution run and its tracking results may be assigned an execution identifier (ID) in the same manner as the first ID, which may be used to identify the data used during execution (e.g., for a specific employee or other conditions).

In one example, the change may be from the user changing one or more input values from the first execution run and re-executing to see how the result changes. The change may be a programming change to the calculation system 130, for example, by modifying a function or calculation expression/formula in the logic/code and then re-executing with the same or different input values as in the first execution run. The reason for re-execution does not affect the functioning of the tracking system 100 as there may be other reasons for re-execution. In one embodiment, a summary of data value changes 125 between each execution run are generated and displayed. This is described in more detail below.

In one embodiment, the re-execution may be performed back-to-back with the first execution run, which makes the association of corresponding tracking results straightforward. In other embodiments, time may pass between executions. To identify the first execution run results after a second execution run, the tracking system may identify and retrieve the first execution run tracking results based on the execution ID used in the second execution run (e.g., an ID that associates the same employee or same conditions as in the first execution run). Thus, the system can match and compare appropriate tracking results between different executions.

The displayed visual results between the two execution runs allows a user to understand how changing one input value impacts the calculations of the executed functions throughout the execution path. Thus, when a value in one of the attributes changes, the subsequent changes to all other attributes downstream are tracked at every step to identify the complete calculation trail. This allows a user to easily diagnose calculation setup issues and to easily understand the calculation logic by following the execution trail visually.

In one embodiment, the dynamic execution tracking system 100 may aggregate and display changed data values and attributes, and executed dynamic functions, alerts, and other details and information in a map, chart, diagram, or tabular form on a graphical user interface (GUI). In one embodiment, the execution tracking system 100 may provide a trail details link or other accessible action item that individually displays a selected data value change, an executed dynamic function, an alert, and/or other parsed data corresponding to details and information for a calculation, condition, and/or expression evaluated at each executed dynamic function and subsequently executed dynamic function.

In one embodiment, the dynamic execution tracker 115 may access dynamic functions 135, attribute data 140, alert data and other execution data 145, from the dynamic calculation system 130. In some embodiments, the dynamic execution tracking system 100 may be integrated into the dynamic calculation system and executed upon a user inputted data value and request. Further, the dynamic execution system 100 may be an application or software configured to run in the foreground or as a background process or thread upon execution of the dynamic calculation system 130.

In one embodiment, the attribute data 140 and their data values may be stored and retrieved from database records and/or computed during run-time by the dynamic calculation system 130. The attribute data 140 may be populated during a run-time or operational process of the dynamic calculation system 130. In some embodiments, a user inputted data value may change one or more other attribute values of the attribute data 140.

Similarly, the alert data and other execution data 145 may be populated and pre-processed by the dynamic execution tracker 100 prior to processing by the dynamic calculation system 130. The alert data and other execution data 145 may include one or more functions for processing the alert. In some embodiments, the alert data and other execution data 145 may include conditional expressions or calculations determined based on one or more data values of attribute data 140.

### Execution Tracking Embodiment

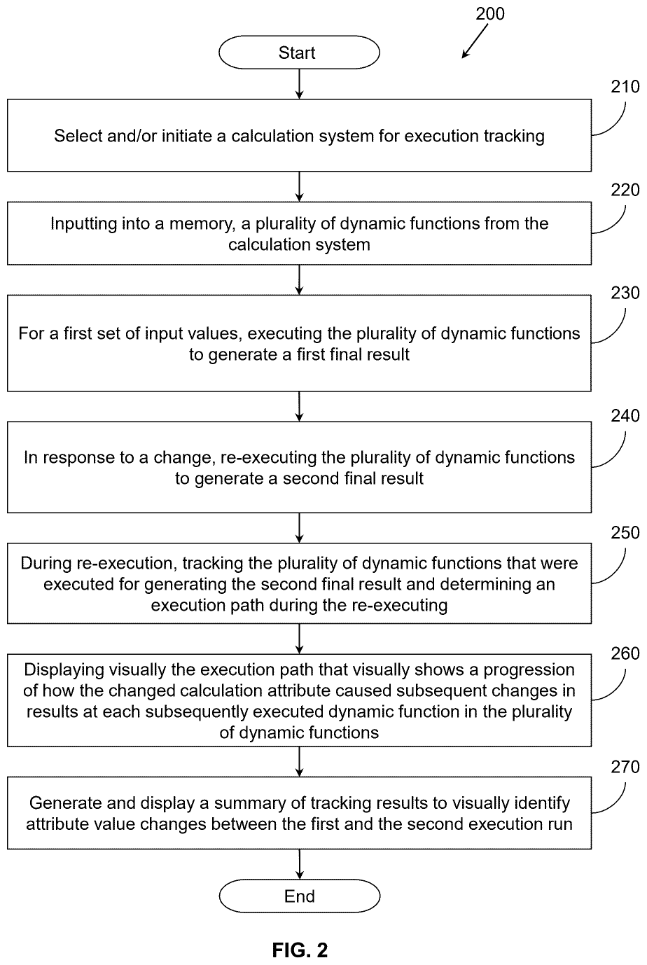

FIG. 2 illustrates one embodiment of a method 200 performed by the dynamic execution tracking system 100 of FIG. 1 for tracking the execution of a complex calculation system and visually displaying data value changes, calculation and/or conditional evaluations, and/or alert processing as part of an execution trail between two execution runs. For example, a user may execute the calculation system based on a first set of input values (first execution run). The user may then re-execute the calculation system (second execution run) after a change is made. As stated above, the change may be from the user changing one or more input values from the first execution run. The change may be a programming change to the calculation system 130, for example, modifying a function or calculation expression/formula in the logic/code. Then the modified calculation system is re-executed with the same or similar input values as in the first execution run.

As one example, a user may execute a compensation calculation system to calculate a compensation for an employee John Doe based on input values from Joe Doe's data record(s) and/or one or more user defined input values. The user may then change one or more of the input values and execute a second execution run for John Doe to see how the final result changes. In another example, the logic of the compensation calculation system may be modified after the first execution run. The user may then re-execute the modified compensation calculation system using the same data from John Doe's records as in the first execution run.

The execution tracking system is configured to track both executions runs, determine how calculation expressions are calculated, trace data value changes, and generate a tracking summary of the execution path. The tracking summary shows how data values changed from the first execution run to the second execution run. The tracking summary may visually identify which data values changed and how they were changed (from the first to the second execution run) as caused by the changed data value and/or by the modified logic.

For example, a compensation administrator who reconfigures/changes a custom calculation logic for calculating a target bonus amount (e.g., calculation expressions) may identify a mistake in the logic after reviewing the tracking results from the first execution and the second execution. The execution trail/path for the second execution will be different from the first execution in this case (due to the mistake/error in the modified logic) although many attribute values are still the same. If the modified logic was correct, then the execution trail/path for the second execution should be the same or consistent with the first execution trail/path since both execution runs used the same input values. This is one example of possible benefits from the execution tracking system 100, which is further described with reference to FIG. 2.

In one embodiment, blocks shown in FIG. 2 may represent one or more processes, methods or subroutines, carried out in the exemplary method. FIG. 1 and FIGS. 3-10 show example embodiments of carrying out the method of FIG. 2 for creating, configuring, and providing an autonomous dynamic execution tracking system for a complex calculation system within a graphical user interface. Method 200 may be used independently or in combination with other methods or processes for creating an autonomous dynamic execution tracking system. For explanatory purposes, the example method 200 is described herein with reference to FIG. 1 and FIGS. 3-10.

In one embodiment, the dynamic execution tracking system 100 with method 200 may generate a unique execution trail that visually displays the progression of data value changes and sequential execution of dynamic functions which track the complex calculation system during execution from input data value(s) to a result. In operation, a user may access the dynamic execution tracking system 100, enter input data values for an entity and identify changes for related or dependent attribute data, and see a progression of calculations and conditions leading to changes in attribute data for the entity.

Method 200 begins at block 210, for example, when an administrator/user accesses the dynamic execution tracking system 100 to perform a first execution run on a selected calculation system. In another embodiment, the user may initiate the selected calculation system, which is configured to be monitored and tracked by the execution tracking system 100.

In block 220, a plurality of dynamic functions from the calculation system may be inputted into memory, for example, as part of the executable code of the calculation system being executed. As previously described, the dynamic functions are configured to sequentially execute as part of an algorithm, although different execution paths may be taken by the algorithm based on a result of a conditional expressions. For example, a conditional expression in a function may be configured to call Function X if an attribute value is greater than 10 or otherwise, call Function Y.

Thus, the execution path may change. As also described, the functions are interdependent on at least one other function in the algorithm based on, for example, one or more calculation attributes. In one embodiment, two functions are interdependent when one function passes an output value to the other function as input. For description purposes, the calculation system will be described as a compensation calculation system that generates a compensation value for an employee based on a set of functions and attribute values, but this is not intended to be limiting.

In one or more embodiments, the dynamic execution tracking system 100 may display a graphical user interface (GUI) configured to display in real-time the status of execution, the attribute data collected, and/or the type and order of dynamic functions processed. In one embodiment, as used in the example below, the dynamic functions include one or more functions that have at least one or more calculation expressions and may include one or more conditional expressions. These may include logical functions programmed in the algorithm to calculate intermediate results, which together produce a final result in the end. The calculation and conditional expressions may be dependent on one or more of the calculation attributes from other dynamic functions. For example, when a calculation expression from one function includes an attribute value that is received from another function, the functions are dependent.

For description purposes, and not intended to be limiting, Table 1 shows a simplified example calculation system with a set of five interdependent functions for calculating a Total Compensation for an employee. The functions are described in functional language, which may be converted into program code in a desired programming language. In general, each function is configured to generate a result value, which is the “Attribute Name,” based on a set of inputs. Thus, Function 1 (below) is configured to calculate the attribute “New Salary” with a particular calculation expression. Rules represent IF-THEN based conditional expressions for determining an attribute result.

TABLE 1

Function 1:
Attribute Name: New Salary
Type: System Calculation
Evaluation Order: 1
Calculation Expression:
New Salary = Old Salary + Salary Change Amount
Rounding Rule: Round to nearest Integer
Function 2:
Attribute Name: New Annual Salary
Type: System Calculation
Evaluation Order: 2
Calculation Expression:
New Annual Salary = New Salary * Salary Annualization Factor
Rounding Rule: Round up to Integer
Function 3:
Attribute Name: Salary Change %
Type: System Calculation
Evaluation Order: 3
Calculation Expression:
Salary Change % = (Salary Change Amount / Old Salary) * 100
Rounding Rule: Round up to tenth
Function 4:
Attribute Name: Bonus Amount
Type: Custom Calculation
Evaluation Order: 4
Calculation Expression:
Bonus Amount = Conditional Expressions (As per rules below)
Rounding Rule: Round down to Integer
Rules and Order:

| Condition | Result Value/Formula |
|---|---|
| 1 IF Performance Rating = “Poor” | 0 |
| 2 IF Performance Rating = “Meets Expectations” | |
| AND Salary Change Amount = 0 | (2/100)*New Annual Salary |
| 3 IF Performance Rating = “Meets Expectations” | |
| AND Salary Change Amount > 0 | 0 |
| 4 IF Performance Rating = “Exceeds Expectations” AND | |
| Salary Change % > 10 | (3/100)* New Annual Salary |
| 5 IF Performance Rating = “Exceeds Expectations” AND | |
| Salary Change % < 10 | (5/100)* New Annual Salary |
| 6 True | 0 |

(This is default condition if all other conditions fail)
Function 5:
Attribute Name: Total Compensation
Type: Custom Calculation
Calculation Expression:
Total Compensation = Conditional Expressions (As per Rules below)
Rounding Rule: No rounding

| Rule Order | Condition | Result Value/Formula |
|---|---|---|
| 1 | IF Department != “Sales” | New Annual Salary + Bonus |
| 2 | IF Department = “Sales” | New Annual Salary + Bonus |
| | | + Travel Allowance |

In one embodiment, a compensation system is used as an example of the calculation system because global organizations with thousands of employees often have complex calculation situations in their compensation system with employees being in different countries, with different currencies, different job roles, different experience levels, etc. In such a scenario, managing the complex compensation calculation setup/configuration (which includes custom conditional logic), visualizing and identifying how exactly the data values were calculated on a related data change is very challenging and not provided by previous calculation systems.

As seen in Table 1, Function 4 (Attribute Name: Bonus Amount) includes six different conditional expressions. Each condition may affect the end result in a different way based on the current data values in the execution run. These types of conditional expressions are hidden from users because they are part of the internal code of an application. During an execution run (and between multiple execution runs), a user cannot see which internal conditional expression was triggered and executed. Thus, the user does not know how the result was affected by the conditions.

The present execution tracking system 100 provides a solution to these problems that identifies the execution paths taken by a dynamic calculation system without any human intervention and provides execution details between multiple execution runs when a data value is changed. As previously stated, when a value in one of the attributes changes, the subsequent changes to all other attributes downstream are tracked at every step to identify a complete calculation trail including prior values and changed values. This allows administrators to easily diagnose calculation setup/configuration issues, and users of the system to easily understand the calculation logic by following the trail visually.

With continued reference to FIG. 2, at block 230, for a first set of input values, the calculation system (the dynamic functions) is executed to generate a first final result. The first set of input values may include values for one or more of the calculation attributes. However, what values are input depends on how the calculation system is configured. The execution is tracked and traced, and execution tracking data is stored for this first execution run. The calculation attributes used throughout the dynamic functions have a first set of calculation attribute values during run-time of the first execution run. These values are identified and stored. This is described in more detail below. In one embodiment, the execution tracking functions as described below for the second execution run also apply to tracking the first execution run and/or any subsequent execution runs. For example, at the start of the first execution run, there may be a certain set of initial attribute values. But, by the end of the first execution run, those attribute values could have changed. The method can capture the execution trail and show the old and new values in a trail summary and/or trail details as depicted for the second execution shown below.

In the functions of Table 1, the first function calculates the attribute “New Salary” and has a Calculation Expression: New Salary=Old Salary+Salary Change Amount. Thus, the first input values used to execute the function would include values for “old salary” and “salary change amount.” The result from Function 1 (New Salary) then propagates to Function 2 (New Annual Salary), which uses the result of Function 1 as input in its calculation expression “New Salary*Salary Annualized Factor.” The execution continues in the algorithm until the final result is outputted, which is “Total Compensation” from Function 5.

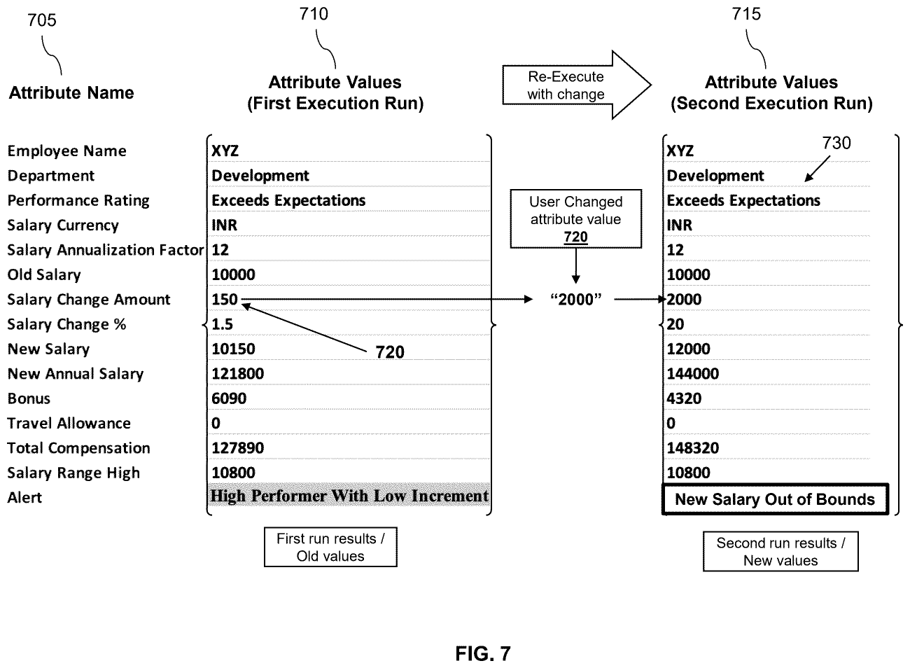

In one embodiment, an example output generated from the execution tracking system from a first execution run involving the calculation system of Table 1 is shown in FIG. 7. A set of attributes that were tracked and identified in the execution are displayed in the column of “Attribute Name” 705. A first column of “Attribute Values” 710 visually displays the data values of the associated attribute name as it occurred during the first execution run. A second column 715 displays the same attributes with their data values (Attribute Values 715) that were tracked and recorded during a second execution run after a data value was changed. This is described with reference to the remaining blocks of FIG. 2.

With reference again to FIG. 2, at block 240, a second execution run may be performed that re-executes the plurality of dynamic functions to generate a second final result after a change is made. For example, the change may be from the user changing one or more input values from the first execution run. The change may be a programming change to the calculation system 130, for example, modifying a function or calculation expression/formula in the logic/code and then re-executing with the same or different input values as in the first execution run. For example, a user may wish to change an input value to see what new final result is generated by the calculation system. This may be performed due to a change in conditions or simply to test the calculation system logic. In response to the user, via a graphical user interface (GUI), changing one calculation attribute value in the first set of attribute values to a second value, the calculation system (the dynamic functions) is re-executed to generate a second final result. Again, this second execution run is tracked and traced by the execution tracking system 100, and execution data is stored for the second execution run. This is described in more detail below.

At block 250, as described above, the execution tracking system tracks the plurality of dynamic functions during the re-execution to identify which functions were executed for generating the second final result and determines an execution path of the functions that were executed during the re-executing (the second execution run).

In one embodiment, the tracking includes determining, from the functions that were executed, how one or more calculation expressions are calculated during the second execution and identifying a second set of calculation attribute values of the calculated expressions that occurred during the second execution.

In one embodiment, the tracking may include identifying triggered conditional expressions, which include conditional expressions from the dynamic functions that were triggered during the second execution. The triggered conditional expressions are included in the execution path.

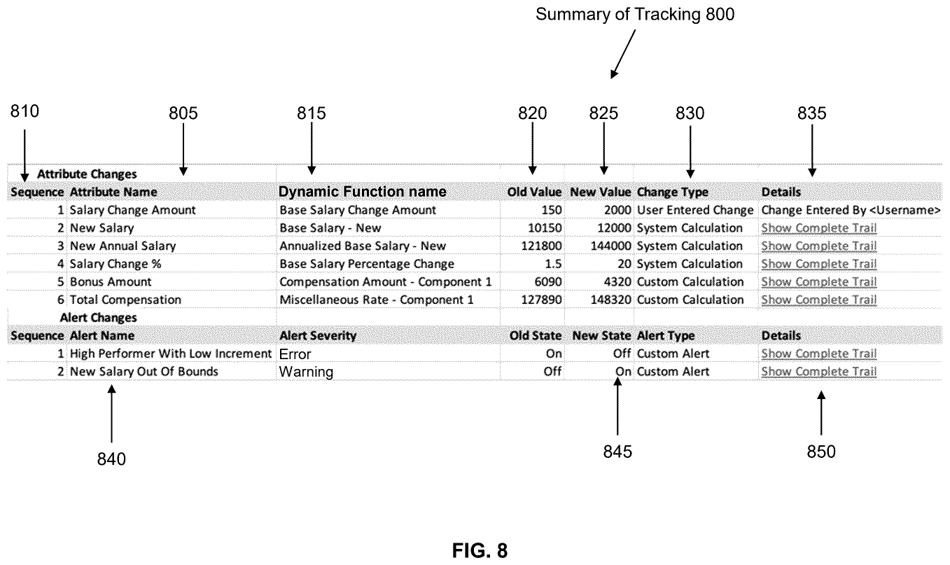

At block 260, the execution tracking system generates and visually displays the execution path that visually shows, for example, a sequence of executed functions and a progression of how the changed calculation attribute caused subsequent changes in results at each subsequently executed dynamic function. The sequence of internally executed functions provides information about the internal processing of the calculation system, which the calculation system does not provide by itself. One example is shown in the second column 715 of FIG. 7 that visually displays the attribute values that occurred during the second execution run, which now may be compared to the tracking results from the first execution run in column 710. FIG. 8 shows an example that visually displays a sequence of executed functions 810 along with their attribute name.

At block 270, in one embodiment, the execution tracking system may generate and display, on the GUI, a summary of tracking results to visually identify attribute value changes between the first execution run and the second execution run. The summary of tracking results includes the first set of calculation attribute values that occurred during the first execution and the second set of calculation attribute values that occurred during the second execution. In one embodiment, FIG. 8 shows an example of a summary of tracking results displayed on a graphical user interface (GUI).

In one embodiment, the execution tracking system, as part of block 260, may determine how the calculation expressions are calculated from the executed dynamic functions and visually displays a first value that occurred during the first execution run and a second value of the calculated expression that occurred during the second execution run (the re-executing). The visual display of the data values from both execution runs allows for a simple visual comparison. See FIGS. 7-8.

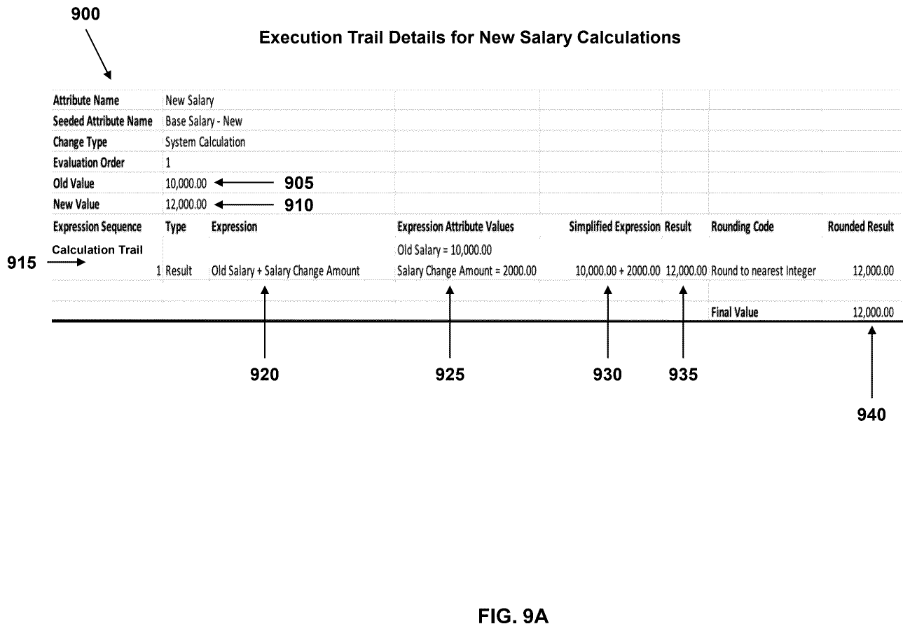

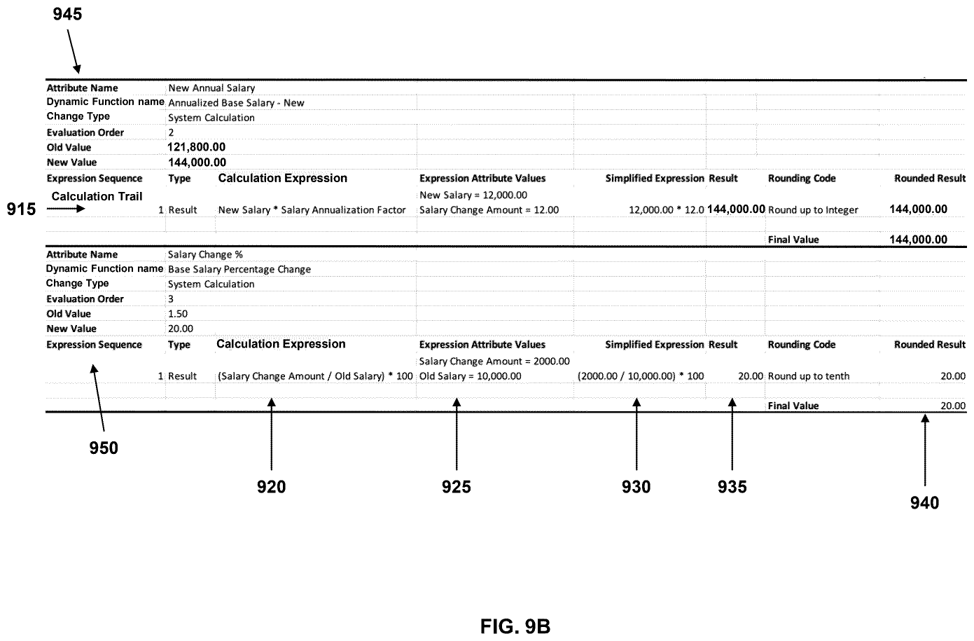

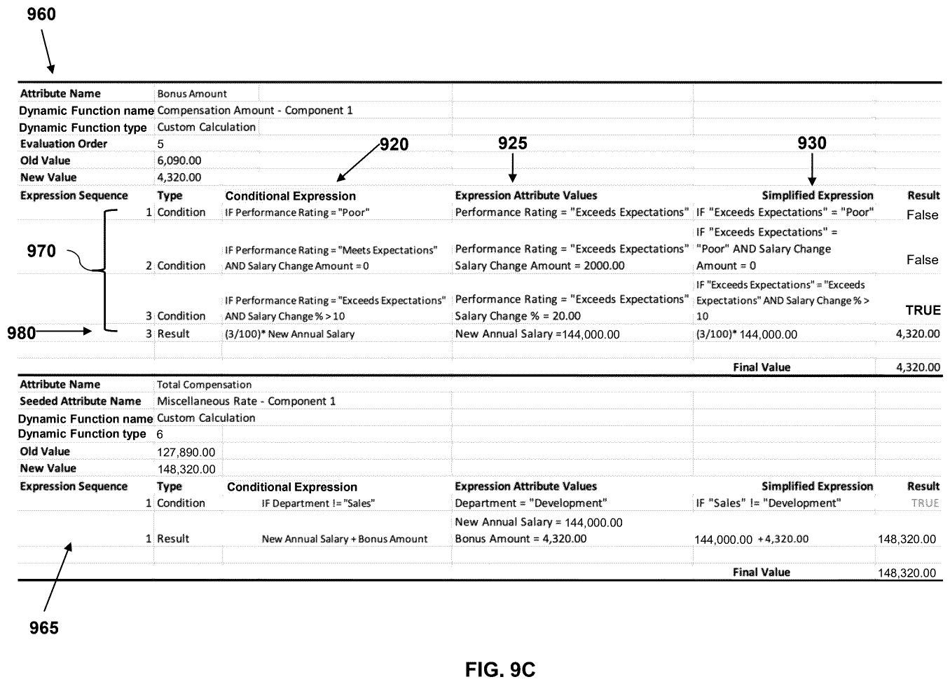

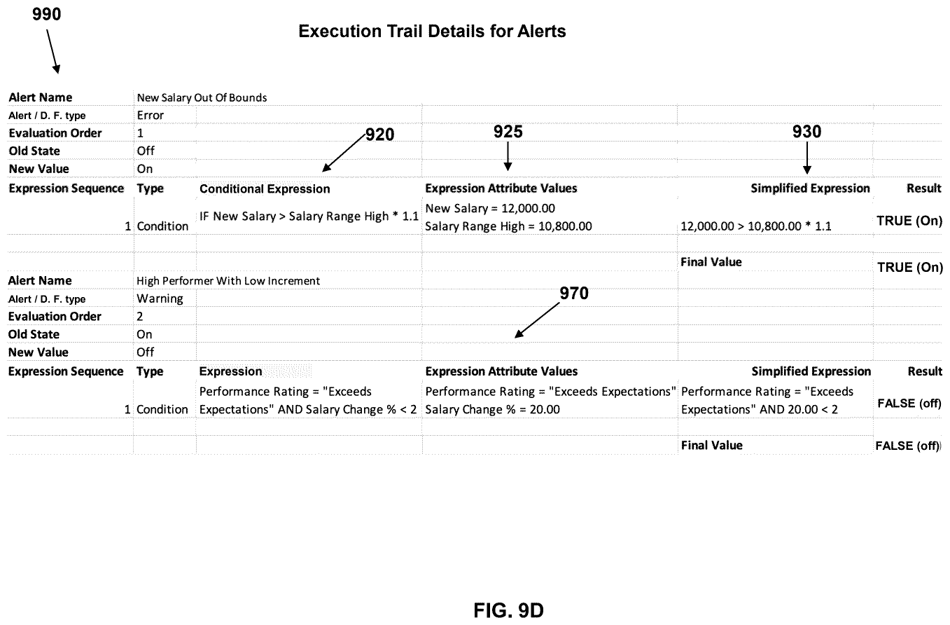

In another embodiment, as part of the tracking results, the execution tracking system may display an execution path taken by the dynamic functions during execution of the one or more conditional expressions based on the first value and the second value of the calculated expression. Visual displays of the tracking results and execution paths are described with reference to FIG. 7 and FIG. 8. FIGS. 9A-9D illustrate more detailed tracking results from FIG. 8.

### Visual Execution Tracking Displays Embodiments

With reference to FIG. 7, as described initially above, the execution tracking system has tracked two execution runs of the calculation system from Table 1. The example visual output may include a set of attributes that were tracked and identified in the execution of the functions. These are displayed in the column of “Attribute Name” 705. A first column of “Attribute Values” 710 visually displays the data values of the associated attribute name as they occurred during the first execution run. In the calculation system of Table 1, there are three (3) main input values needed for execution: (1) Old Salary, (2) Salary Change Amount, and (3) Salary Annualized Factor. All other attribute values may be calculated from the initial input. The final result of Total Compensation is “127890.”

A second column 715 displays the data values (Attribute Values) for the same attributes that were tracked and recorded during the second execution run after a data value was changed. In this example, the data value that is changed is “Salary Change Amount” 720. In the first execution run, the value is “150” and this value was changed in the second execution run to be “2000” (e.g., by a user input). Here, the final result of Total Compensation is now “148320.”

This one value change causes a number of changes to other attribute values since the functions are interdependent. The visual display of the execution tracking provides detailed information about how the change impacted other functions and attribute values, which would not be visible or known without the present execution tracking system.

With reference to FIG. 8, another embodiment of an example visual tracking output 800 is shown as a Summary of Tracking Results that may be generated from tracking the two execution runs of FIG. 7. The summary shows all changes that happened in the calculation system after the value change of the one attribute that triggered a chain of calculations in the second execution run.

The execution tracking system captures a complete execution trail including, for example, the functions executed 805 (also called “Attribute Name” in the above examples), a sequence of execution 810, and a dynamic function name 815 associated with the executed function. The visual tracking output 800 also includes attribute value changes from the first execution run (Old Value 820) to the second execution run (New Value 825).

Additional tracking information may also be provided, for example, a change type 830 relating to what caused the associated change in value between the executions runs. This tracking information may be informative since it may identify which data values were changed by the user and which data values were changed by the system as part of the functions executing. For example, in the type column 830, Function 1 “Salary Change Amount” shows “User Entered Change.” Thus, this indicates that the associated value was changed by the user after the first execution run.

In the example above, recall that the user changed the Salary Change Amount from “150” to “2000” and re-executed the calculations. All the other types are “System Calculations” or “Custom Calculations” that represent values generated by the calculation system and not due to a direct user change. The system-changed values show the impact or result caused by the user-changed value. The labels used are not intended to be limiting since other types of labels may be used.

The summary of tracking 800 may also visually show when any alerts or warnings are triggered during the execution run. For example, as seen in FIG. 8, after the user changes the “Salary Change Amount” to a value of “2000” in the second execution run, a warning is triggered. The alerts/warnings 840 show that an alert “New Salary Out of Bounds” has been triggered, which previously was not triggered. This is seen by the transition from Old State “Off” to New State “On” at 845. Seeing the state transition may alert the user that something is suspicious and should be investigated.

In one embodiment, the tracking system 100 may automatically detect suspicious execution runs and/or data value changes when certain alerts or warnings are triggered from one execution to another execution. The tracking system 100 may generate an additional alert, for example, visually highlighting the newly triggered alert on the GUI tracking display 800 as well as the user data change that caused the trigger. In another embodiment, a pop-up window may be displayed that identifies the newly triggered alert/warning along with the user change. Identifying one or more alerts triggered in the execution path caused by one or more changed calculation attribute values may allow the tracking system and/or the user to determine conditions that led to different execution paths, unexpected results, and/or logical faults.

A Details column 830 may also be provided to indicate more specific information about what changes or calculations occurred for a particular Function/Attribute Name. In the first line, the “Salary Change Amount” is identified as “Change Entered By <Username>” where username identifies the user that made the change to the attribute. Since this is simply a user-change, there are no other details.

The remaining rows display “Show Complete Trail.” This may be generated and displayed as a selectable link (an execution trail link) that displays additional execution trail details for the associated function/attribute name. For each such function/attribute name, details of how that change happened can be viewed by clicking the “Show Complete Trail” link (or by other means of viewing details for each of the rows, such as a row disclosure on each row of attribute change). When a trail link is selected by a user, execution trail details are displayed that show how the attribute was calculated during execution. The details may show how calculations were performed, which are displayed in a user interface, for example, as shown in FIGS. 9A and 9B. This may be generated via a pop-up window or a new user interface screen.

With reference to FIG. 9A, upon selection of the “Show Complete Trail” link in Row 2 for the “New Salary” function/attribute name in FIG. 8, a display screen with execution trail details 900 is generated and displayed. The execution trail details 900 show, for example, the Old Value 905 (“10,000”) of the new salary attribute that was generated in the first execution run and the New Value 910 (“12,000”) that was generated in the second execution run. This shows the impact of the changed data value (Salary Change Amount) on this particular function in the calculation system.

Additional details represent a calculation trail 915 of how the function executed and what internal calculation expressions (e.g., logic) were executed as part of the function may be displayed. This may include showing an expression sequence of an order of internal calculations that were executed and how the calculation expression 920 is actually defined. In this example, there is only one (1) expression in the sequence and the expression is Old Salary+Salary Change Amount which determines the result for the attribute “New Salary.”

Further internal details and/or internal logic of the calculations may be displayed, which show how the function is programmed and what the run-time data values are. For example, the attributes and their attribute values 925 that were used in the calculation expression may be displayed. Also, a display of what the expression looks like with the attribute values are inserted/substituted into the expression is shown in a Simplified Expression 930. A Result 935 of the simplified expression 930 is displayed as well as a Final Result 940 after any other calculation adjustments are made, if any (e.g., a rounding code).

FIGS. 9B and 9C show similar execution trail details for the other functions/attribute names that may be generated and visually displayed upon selecting their associated Show Complete Trail link (from FIG. 8), in one embodiment. Execution trail details 945 correspond to the function/attribute name “New Annual Salary” and execution trail details 950 correspond to the function/attribute name “Salary Change %.” In one embodiment, the execution details for each function may be individually displayed based on a specific show trail link selection or multiple executions details may be displayed together for multiple functions.

FIG. 9C shows similar execution trail details as FIGS. 9A and 9B at a function level for the other functions/attribute names that have been collected during execution tracking. The details may be generated and visually displayed upon selecting a function's associated Show Trail Details link (from FIG. 8), in one embodiment. Execution trail details 960 correspond to the function/attribute name “Bonus Amount” and execution trail details 965 correspond to the function/attribute name “Total Compensation.”

As seen in FIG. 9C, these functions each include multiple calculation expressions including conditional expressions 970 (e.g., IF-THEN logic), which make up its calculation trail during execution. This type of visual display of the internal logic of each function may provide helpful information. The visual display may help to explain how a function is processed by the calculation system and how the function was impacted by the data value change caused by the user-change. The visual calculation trail, which tracks the execution of this function with the conditional expressions 970, highlight and identify which conditional expression was triggered (where Result=TRUE) and which conditions were not triggered (where Result=FALSE). The calculation trail also shows how/why the conditions were triggered or not triggered by the display of the Attribute Values 925 and Simplified Expressions 930 that show how the conditions were evaluated.

The internal logic of the conditional expressions 970 is hidden and not accessible by a user for a typical software application. However, the execution tracking system 100 is configured to retrieve and expose this logic in a visual display on the GUI. Furthermore, the execution tracking system 100 may identify and display examples of the different possible scenarios for the conditional expressions 970 in view of different expression values that are input to the expressions.

For example, there are three different logic conditions in the conditional expressions 970, which produce different outcomes based on what the expression attribute values are. The execution values of those attributes are shown in column 925 as “Expression Attribute Values” and the “Simplified Expression” 930 shows the attribute value(s) inserted into the calculation expression. For each different conditional expression, the user can visually see what the expression logic was and what the actual “Result” of the condition was, such as “TRUE” or “FALSE.”

As will be explained below, the execution tracking system evaluates the “IF” portion of the “IF-THEN” condition expressions one-by-one that are associated with a given Function/Attribute Name until it finds the triggered condition with the TRUE evaluation. In this example, the system processed three conditional expressions until the TRUE result is found. From the execution tracking details, the user can visually see that the third “IF” condition was “TRUE” during the execution and that was the conditional expression 970 that was executed by the bonus function. In line 980, the Result details of the condition are shown, which correspond to the “THEN” portion of the condition. Here, the tracking details show that as a result of the triggered condition, the function executed the expression “(3/100)*New Annual Salary.” This gave the final result of “4,320.00” and this was the calculated value of “Bonus Amount.”

With reference again to FIG. 8, in another embodiment, the summary of tracking 800 that is generated may include a portion for alerts 840 that may be generated by the logic of the calculation system. Various properties of the alerts may be extracted from the logic of the functions, for example, alert severity. The Old State 820 and New State 825 are shown for each alert representing the condition of the alert during the first execution run and the second execution run, respectively. The Show Complete Trail links 850 are similar to the other links 835. Upon selection of the trail link, execution details of the alert logic may be generated and displayed in a user interface.

FIG. 9D shows one embodiment of execution trail details 990 for the two alerts from FIG. 8, which may be generated and displayed on the GUI. These may be configured in a similar manner as the execution details of FIGS. 9A-9C.

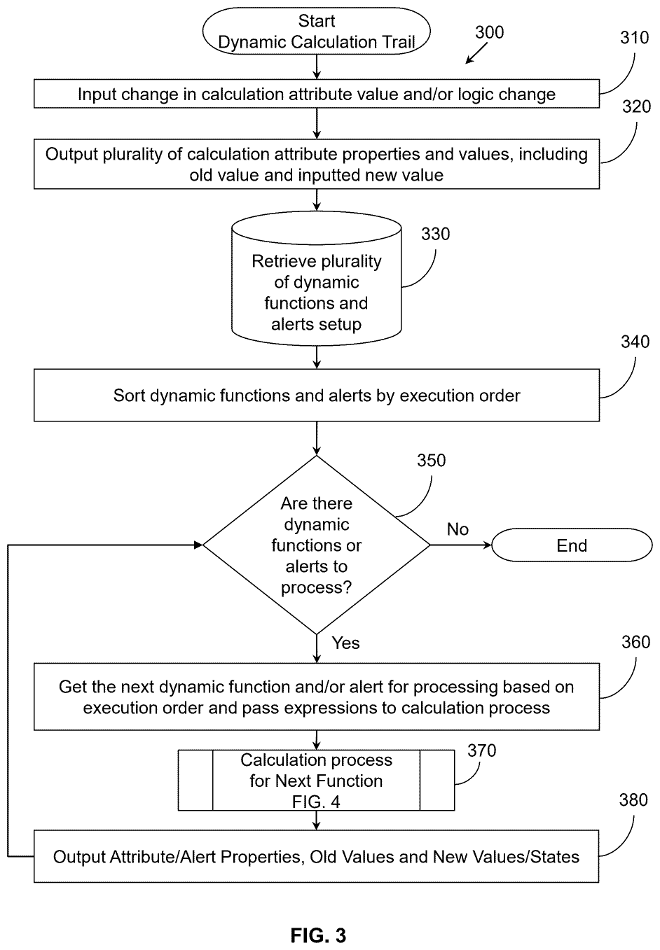

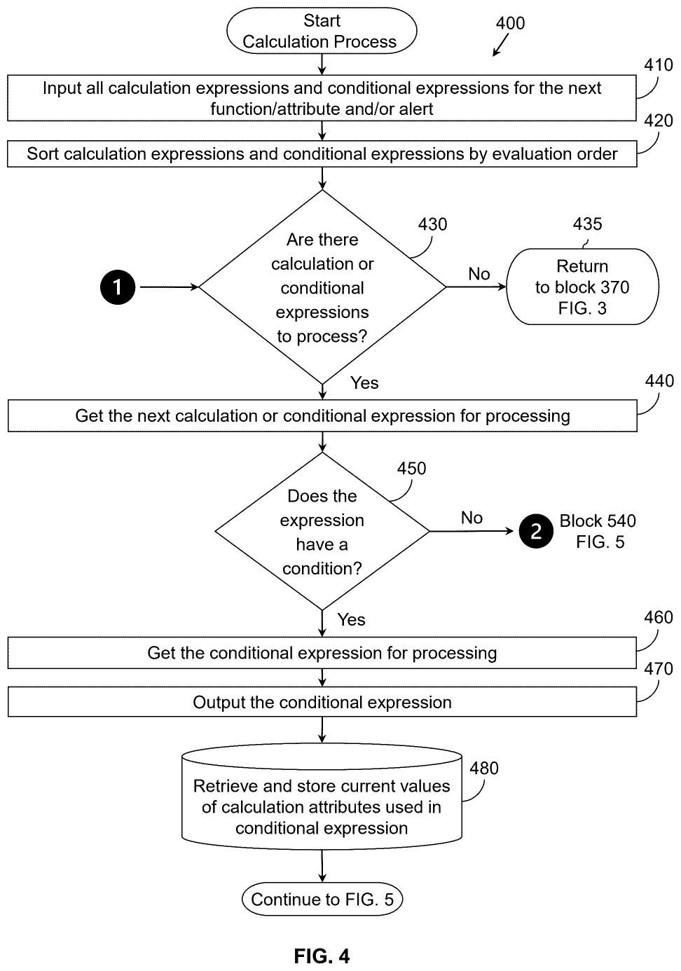

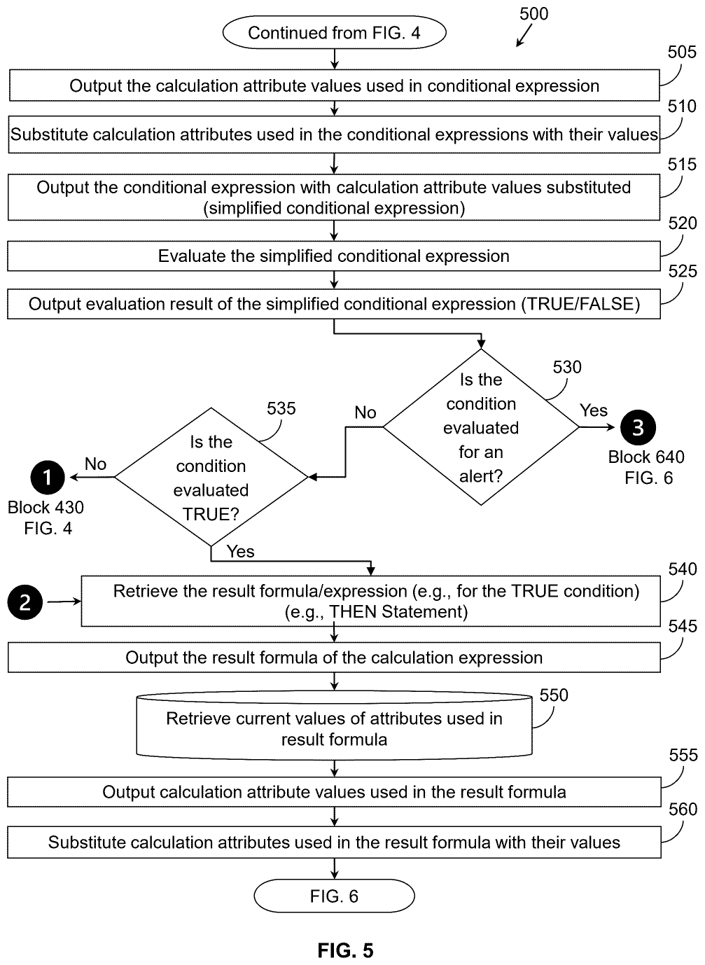

With reference to FIG. 3, one embodiment of a method 300 is illustrated that shows a run-time or operational method performed by the dynamic execution tracking system 100 of FIG. 1 for tracking the execution of a complex calculation system. Method 300 includes one embodiment of block 250 of FIG. 2 for tracking functions during execution and block 260 for determining how expressions and conditions are calculated. Although blocks 250 and 260 refer to the second execution run, those blocks and method 300 may apply for tracking the first execution run and/or other execution runs. FIGS. 4-6 illustrate one embodiment of sub-steps associated with method 300 as described below. The tracked information may then be visually displayed including, for example, data value changes, calculation and conditional evaluations, and alert processing as an execution trail sorted by execution order.

Blocks shown in FIG. 3 may represent one or more processes, methods or subroutines, carried out in the exemplary method. FIGS. 1-2 and 4-10 show example embodiments of carrying out the method of FIG. 3 for creating, configuring, and providing an autonomous dynamic execution tracking system for a complex calculation system within a graphical user interface. Method 300 may be used independently or in combination with other methods or processes for creating an autonomous dynamic execution tracking system for a complex calculation system. For explanatory purposes, the example method 300 is described herein with reference to FIGS. 1-2 and FIGS. 4-10.

In one embodiment, method 300 may be implemented and performed by the dynamic execution tracking system 100 of FIG. 1. With the dynamic execution tracking system 100, a unique execution trail that visually displays the progression of data value changes and sequential execution of dynamic functions and alerts, which track a calculation system during execution from input data value to a final result. In operation, a user may access the dynamic execution tracking system 100 (or a calculation system that is configured with the execution tracking system 100), enter data values for the calculation system and execute the calculation system. Execution may be performed multiple times for different data values. Method 300 may identify changes of attribute data values, and display a progression of calculations and conditions leading to changes in attribute data between two or more subsequent executions.

Method 300 is discussed from a perspective where the calculation system has been executed (first execution run) with a set of input values. The execution tracking system has tracked and traced the first execution run and has stored the execution tracking data. In method 300, references to “Old Values” refer to the attribute values from the first execution run. Reference to “New Values” or “New States” refer to the attribute values/states from a second execution run.

Method 300 begins at block 310, for example, when a manager, administrator, or user inputs or changes in a value of one or more attributes in the calculation system and re-executes (second execution run). In one or more embodiments, the input change or change in attribute values of one or more calculation attributes may be facilitated by a script, program, schedule, organization policy, or otherwise by another remote or local computing device. In another embodiment, the second execution run may also be initiated after a logic change is made to the calculation system with or without changing the input values, as described previously.

In one or more embodiments, the dynamic execution tracking system 100 may display a graphical user interface (GUI) configured to display in real-time the status of execution and tracking, the attribute data collected, and the type and order of dynamic functions processed. As one example, referring to FIGS. 7 and 8, an input is received corresponding to an attribute value (e.g., “Salary Change Amount”) that changes the attribute value for a second execution run.

With reference again to FIG. 3, at block 320, the dynamic execution tracking system 100 outputs the attribute properties and values that are known prior to execution, including the old value and the inputted new value of the changed attribute. Known values include input attribute values that do not change during execution, but may cause changes to other attribute values during execution.

At block 330, the dynamic execution tracking system 100 retrieves the plurality of dynamic functions and alerts setup from the calculation system being tracked. For example, the functions may be retrieved from the executed code and/or the programming code of the calculation system. The functions may be retrieved from an execution log that was previously generated or during run-time as the calculation system is executing.

At block 340, the dynamic execution tracking system 100 may sort the dynamic functions and any alerts by execution order. In one embodiment, a sorted sequence of executed functions may be visually displayed (e.g., see FIG. 8 sequence 810).

With reference again to FIG. 3, at block 350, the dynamic execution tracking system 100 determines whether there are any other dynamic functions or alerts to process. This condition block sets up an iterative process for evaluating one or more functions that may be present. If there are no other dynamic functions or alerts to process the dynamic execution tracking system 100 ends tracking and displays execution tracking results from the two execution runs (e.g., see FIG. 8 summary of tracking 800). Since this is the first pass of the method, there are functions to process, and the method moves to block 360.

At block 360, the dynamic execution tracking system 100 retrieves the next dynamic function (which here would be the first function) including its attributes/properties/calculation expressions that were executed in the calculation system from tracking analysis. Using the calculation system example from Table 1, the first retrieved function is for the attribute name “New Salary.” The method passes the properties (e.g., expressions, attributes, etc.) of the retrieved function to block 370 to perform a calculation process that evaluates the function. Block 370 is described with reference to FIGS. 4-6 below.

At block 380, when the method returns from FIGS. 4-6 (after the calculation process 370 is completed for the evaluated function), the execution trail and tracking results are outputted and visually displayed on the GUI for the evaluated function. In one embodiment, the tracking results may include attribute properties, any alert properties, condition expressions, and old values and new values/states of the attributes for the evaluated function. For example, in FIG. 8, the Function/Attribute Name “New Salary” (line 2 in sequence) shows a summary of tracking details for the function. FIG. 9A shows one example of detailed tracking information for the New Salary function. FIG. 8, as a whole, shows one example of a completed summary after all functions of the calculation system are evaluated by method 300.

In one embodiment, the method may output the evaluation results for each function into memory or a file until all evaluations are complete. Then the method may generate the entire summary of tracking for all functions together (e.g., see FIG. 8).

After evaluation of the current function and output at block 380, the method returns to block 350 and repeats for the next function in the calculation system.

With reference to FIGS. 4-6, one embodiment of the calculation process block 370 (FIG. 3) is shown as method 400 (referred to as calculation process 400). The calculation process 400 evaluates the logic and expressions configured in the next function being analyzed that are passed from the previous block 360 of FIG. 3.

FIG. 4 illustrates one embodiment of a run-time or operational method associated with the autonomous dynamic execution tracking system of FIG. 1 and/or block 370 of FIG. 3. Blocks shown in FIGS. 4-6 may represent one or more processes, methods or subroutines, carried out in the exemplary method.

Referring to FIG. 4, method 400 begins at block 410, where the calculation expressions and conditional expressions from the function being evaluated are input. Using the example from Table 1, when Function 1 (New Salary) is being evaluated, its calculation expressions include “New Salary=Old Salary+Salary Change Amount.” When Function 4 (Bonus Amount) is being evaluated, its calculation expressions include a set of rules that define six conditional expressions.

In block 420, the calculation expressions and conditional expressions are sorted by evaluation order. The evaluation order may be defined and identified in the function configuration itself, for example, as shown in Table 1 parameter “Evaluation Order” and Rules Order.” The evaluation order may also be determined from the execution data and/or programming code, in one embodiment.

In block 430, an iterative processing loop begins to evaluate each calculation expression and conditional expression (if any) that are part of the function being evaluated. If there are no expressions to evaluate, or when all expressions have been evaluated, the method moves to block 435 and processing returns to block 370 (calculation process 370 of FIG. 3) for continuation to output block 380. If there are other calculations or conditional expressions to process, the dynamic execution tracking system 100 and the method moves to block 440.

In block 440, the dynamic execution tracking system 100 retrieves the next calculation or conditional expression from the function being evaluated for processing. In one embodiment, the expressions are stored in memory or a data file and are retrieved by the system.

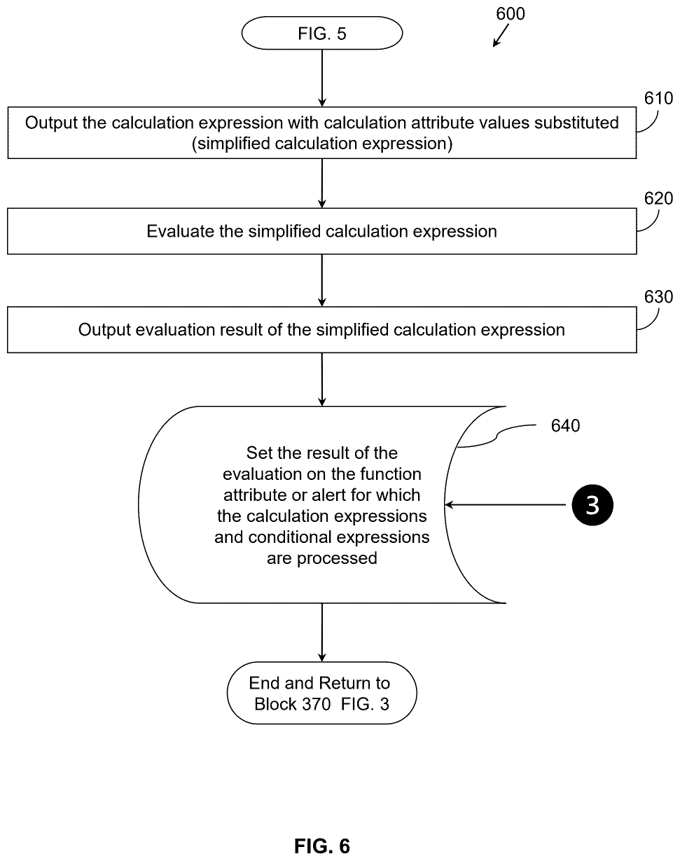

In block 450, the dynamic execution tracking system 100 determines whether the retrieved calculation expression has a condition (e.g., rules for conditional expressions). For example, Function 1 from Table 1 has no conditions, whereas Function 6 has conditions. If there are no conditions to process, the method continues to block 540 in FIG. 5 described below, where the expression is the result formula (e.g., there are no other possible conditional formulas).

If there are conditions to process, the method continues at block 460, which is part of an iterative process to evaluate each conditional expression found in the function being evaluated. The iterative process is evaluating the multiple IF-THEN conditional expressions to find the one that is triggered during execution (the condition evaluated as TRUE).

In block 460, the dynamic execution tracking system 100 retrieves the conditional expression from the function for processing. This may include accessing the memory and/or code to identify and retrieve the expression. In block 470, the dynamic execution tracking system 100 outputs the “IF” conditional expression to the calculation process and/or to the GUI for visual display. For example, FIG. 9C shows calculation/conditional expressions 920 for the group of conditional “IF” expressions 970.

In block 480, the dynamic execution tracking system 100 retrieves current values of the calculation attributes used in the conditional expression. In one embodiment, the current values of the attributes may be retrieved by accessing the execution log and/or retrieving run-time values for the attributes of the expression. The evaluation and method continue to FIG. 5.

Referring to FIG. 5, at block 505, the retrieved values for the attributes using the conditional expression are outputted to the calculation process and/or generated for display on the GUI. For example, in FIG. 9C, attribute values 925 are displayed to show the value of each attribute involved in the expression.

At block 510, the calculation attribute values used in the condition expression are substituted in the conditional expression and a simplified conditional expression is generated and outputted at block 515. For example, FIG. 9C shows a generated simplified expression 930 that may be visually displayed that shows the data values inserted into the conditional expression, in one embodiment. The simplified expression 930 shows the current values substituted into the expression to visually show how the expression is calculated. Note that in FIG. 9C, all the simplified expressions from the multiple conditions 970 are shown together, which would occur after methods 400 and 500 completed their evaluations.

In block 520, the dynamic execution tracking system 100 evaluates the simplified conditional expression and outputs the evaluation result in block 525. Again, in the example GUI in FIG. 9C, a visual result is generated and displayed next to the corresponding conditional expression to visually show the user the result (e.g., TRUE or FALSE) of the “IF” condition based on the current run-time values of the attributes.

In block 530, in one embodiment, the dynamic execution tracking system 100 may determine whether the condition evaluated is for an alert. For example, a conditional expression may be configured to generate an alert message when a result value meets some defined condition or threshold. FIG. 9D shows an example of execution trail details for example alert conditions.

If the condition evaluated is for an alert, the method moves to block 640 of FIG. 6, which is the last step in the evaluation of the current function. At block 640, the result of the evaluation of the function/attribute name being evaluated (whether for the calculation expression/attribute or the alert expression) is set and stored in the execution trail details. The method then returns to block 370 in FIG. 3 where the execution trail details are outputted and graphically generated as part of the visual trail on the GUI (e.g., see FIG. 7 or FIG. 8).

Returning to FIG. 5, if at block 530, the condition evaluated is not an alert, the method continues in block 535 to determine whether the “IF” condition evaluated resulted in being TRUE or FALSE. The conditional expression whose result is TRUE is the expression that is executed because its “IF” condition is triggered by the current attribute values. Any other conditional expressions that are FALSE are not executed in the current execution run.

If, at block 535, the condition evaluated is FALSE, that means the conditional expression was not triggered and thus was not executed. No further details are added to the execution trail details for the false conditional expression. The method returns to block 430 (FIG. 4) to process the next expression, if any remain in the current function being evaluated.

If the condition is “TRUE” at block 535, the method continues to block 540 to retrieve a result formula/expression for the TRUE condition. The result formula/expression refers to the “THEN” portion of a conditional IF-THEN statement. For example, in the condition IF X, THEN Y, the “Y” is the result formula/expression. In some scenarios, the result formula may be a single value.

In another example, in the execution trail in FIG. 90, the third condition (e.g., #3 in sequence) “IF Performance Rating=“Exceeds Expectations” AND Salary Change %>10″ has a result of “TRUE.” Thus, the system retrieves the result formula/expression (e.g., the THEN portion) that is executed when that condition is TRUE. This is found in the code, for example. Looking at Table 1, the condition expression (Rule #4) “IF Performance Rating=“Exceeds Expectations” AND Salary Change %>10″ has an associated result formula/expression of “(3/100)*New Annual Salary.” This is retrieved in block 540.

At block 545, the retrieved result formula/expression (e.g., the THEN statement for the TRUE condition) is outputted, and data is generated on the GUI display as a line in the execution trail details. For example, in FIG. 9C, the result formula/expression is displayed in line 980 (Type=Result) and Expression 920 is “(3/100)*New Annual Salary.” Since this condition is TRUE, its result formula/expression is triggered and executed during execution. The executed formula becomes part of the execution trail to show which conditional expression was executed and how it was executed.

In block 550, similar to block 480, the current values of the attributes used in the result formula/expression are retrieved. In the example result formula “(3/100)*New Annual Salary,” the attribute value for New Annual Salary is retrieved.

In block 555, the dynamic execution tracking system 100 may output the attribute values used in the result formula. The values may be generated and displayed on the GUI. Using the same example from FIG. 9C, the attribute value is displayed as “New Annual Salary=144,000.00” in column 925.

In block 560, the dynamic execution tracking system 100 may substitute calculation attributes used in the result formula with their values. This is to evaluate the expression and also generate a simplified expression in visual form for display in the trail details, which is performed in the next step in FIG. 6. The method continues to FIG. 6.

At block 610, the result formula with the values of the attributes substituted/inserted into the formula are used to generate a simplified calculation expression to visually show how the expression was calculated. An example is shown in FIG. 9C as “(3/100)*144,000.00” in column 930.

In block 620, the dynamic execution tracking system 100 may evaluate the simplified calculation expression and output the final result at block 630. As seen in FIG. 9C, in the “Result” column, the result is shown as “4,320.”

In block 640, as previously described, the result of the evaluation of the function (whether for a calculation expression/attribute or an alert expression) is assigned to the function/attribute name that is being evaluated. The result is stored in the execution trail details. Thus, for the example in FIG. 9C, the result of “4,320.00” is assigned to the Function/Attribute Name “Bonus Amount.” The evaluation of the execution of the function is complete. The method will return and repeat for the next function in the calculation system.

Thus, the method returns to block 370 (Calculation Process for the Next Function) in FIG. 3, which started the calculation process of FIG. 4. At this point, the evaluation of the calculation process for the function being analyzed is complete. Moving to block 380 of FIG. 3 (as described previously), the execution trail details are outputted and generated as part of the visual trail on the GUI (e.g., see FIG. 7 or FIG. 8). The method of FIG. 3 then repeats for any additional functions in the calculation system at block 350.

With the present autonomous dynamic execution tracking system, changes in the data values, dynamic calculations, and triggered conditional calculations and/or alerts can be tracked and displayed visually to identify the execution path taken in a dynamic calculation system without human intervention. This is useful to compare results between multiple execution runs by providing execution trails of the functions and visually show which attributes changed and how they changed.

As explained, when one input value is changed, the change may trigger changes to other attributes, which are identified and exposed by the present tracking system. This allows, for example, an administrator to easily diagnose calculation/logic setup issues by executing test runs. The present execution trail details also allow users to easily understand the calculation logic of a calculation system by following the execution trail visually.

Thus, the present execution tracking system may generate visual details of how dependent attributes/alerts changed and provide a step-by-step tracked trail allowing users to know exactly what data values, dynamic functions, and alerts were calculated or changed. The graphical visual trail results of the present system may help to diagnose and/or troubleshoot any potential alerts, identify errors in the calculation code, or identify unexpected results. Such features were not available in previous calculation systems and thus is an improvement over previous technical tracking processes.

The dynamic execution tracking system 100 may be autonomous to simplify result generation such that an administrator may generate period reports by automatically executing the execution tracking system to populate an execution trail showing processing steps for one or more inputs in a dynamic calculation system. The execution tracking system 100 simplifies what may otherwise be a complex, if not impossible, process of tracking and evaluating data value changes and potential dynamic calculation trails to determine how an unexpected result, error, or result was reached in the dynamic calculation system. Without the execution tracking system operating with a dynamic calculation system, it may be very difficult to determine how data values change, what caused errors or unexpected results, and how to diagnose or troubleshoot errors or alerts.

As an example, global organizations with thousands of employees often have large complex calculations that process interdependent data accessed from multiple systems, remote computers, or databases to obtain a result. In many cases, the system acquires numerous data values and attributes for each employee from multiple data records that change throughout their term within the organization. Simply accessing the data records from multiple disparate systems that use different data formats is a challenge. It is even more challenging to understand how changes in data values and attributes propagate through a complex dynamic calculation system (e.g., accounting, tax, finance, product simulation or testing, insurance, compensation, etc.,) that relies on the data records. It is very challenging and time-consuming because the software system code is not accessible to users. The code is typically hidden and/or in executable form, which is not human readable. Even user manuals do not explain step-by-step calculations made by the software code. Furthermore, any documents that explain step-by-step calculations (which are static) fail to provide any assistance when dealing with real-time data values and real-time execution details of the software.

In previous software systems, attempting to identify, visualize, and understand how interdependent data within dynamic calculation systems subsequently change would require manually evaluating the program code and tracking every step of computation and data change. For example, when a data value changes, then subsequent changes to other data values downstream are not seen or tracked. Thus, a user cannot detect issues with the data, with the calculation or conditions, or with system processing. This makes it difficult for administrators or users to diagnose calculation configuration issues, understand the calculation logic, or find any errors. With the present execution tracking system, the system may automatically detect suspicious errors or issues with a calculation process based on the execution tracking performed between two execution runs as explained above.

Previous dynamic calculation systems fail to identify each process that contributes to the change in data values and attributes and interdependent processes that process the changed data values downstream. For example, a data value previously entered in combination with a current data change may result in a specific condition being satisfied within the configured algorithms/functions. Hence, the executed functions may divert and use a different calculation formula than was expected. This type of internal execution event/condition would be unknown to the user.

In previous systems, when a manager or administrator makes changes to data values and re-executes a calculation system, although the dependent attributes and alerts get calculated, there is no way to identify how those calculations progressed. Moreover, previous systems lack a means to know when defined conditions have logical faults (e.g., incorrect programming or configuration of a function), which lead to different evaluation paths resulting in unexpected data.

Further, previous systems fail to show an order of evaluation when one of the data points (used in a formula) changes and how the change affected the calculation outcome. Thus, with previous systems, any kind of unexpected result requires manual intervention and analysis taking valuable time and effort to find out what paths a dynamic calculation engine has taken to arrive on a final result. Thus, the present execution tracking system provides a technical solution as described herein to identify, visualize, and understand which interconnected processes, data values, and/or attributes change in response to an input value changing in a dynamic calculation system performing complex calculations.

### Computing Device Embodiment

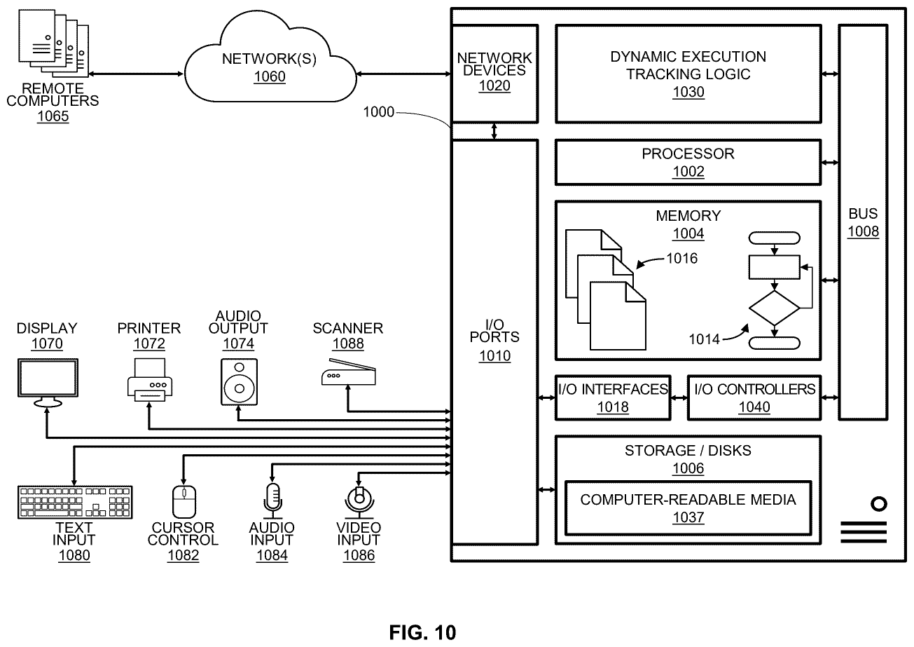

FIG. 10 illustrates an example computing device that is configured and/or programmed as a special purpose computing device with one or more of the example systems and methods described herein, and/or equivalents. The example computing device may be a computer 1000 that includes at least one hardware processor 1002, a memory 1004, and input/output ports 1010 operably connected by a bus 1008. In one example, the computer 1000 may include dynamic execution tracking logic 1030 configured to facilitate tracking of execution paths in dynamic systems as the dynamic execution tracking system 100 and associated figures. The dynamic execution tracking system logic 1030 tracks data values of a plurality of calculation attributes and each dynamic function execution operating on one or more data values of the plurality of calculation attributes. The dynamic execution tracking system logic 1030 may then be used to generate a sequence or trail of data value changes and dynamic function executions that change each data value from a previous state (previous dynamic functions execution) to a current state (current dynamic functions execution), as previously described herein. In different examples, the logic 1030 may be implemented in hardware, a non-transitory computer-readable medium 1037 with stored instructions, firmware, and/or combinations thereof. While the logic 1030 is illustrated as a hardware component attached to the bus 1008, it is to be appreciated that in other embodiments, the logic 1030 could be implemented in the processor 1002, stored in memory 1004, or stored in disk 1006.

In one embodiment, logic 1030 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate tracking of execution paths in dynamic systems through a graphical user interface creating a list of executed dynamic functions, data value changes for a set of calculation attributes, any triggered alerts, and displaying visually a simplified expression for each calculation expression and conditional expression so that an administrator, manager, or end user can easily identify and evaluate how an inputted data was subsequently processed in a management system, what data values changed and what caused unexpected errors, results, or alerts to trigger. The means may also be implemented as stored computer executable instructions that are presented to computer 1000 as data 1016 that are temporarily stored in memory 1004 and then executed by processor 1002.

Logic 1030 may also provide means (e.g., hardware, non-transitory computer-readable medium that stores executable instructions, firmware) for performing one or more of the disclosed functions and/or combinations of the functions.

Generally describing an example configuration of the computer 1000, the processor 1002 may be a variety of various processors including dual microprocessor and other multi-processor architectures. A memory 1004 may include volatile memory and/or non-volatile memory. Non-volatile memory may include, for example, ROM, PROM, and so on. Volatile memory may include, for example, RAM, SRAM, DRAM, and so on.

A storage disk 1006 may be operably connected to the computer 1000 via, for example, an input/output (I/O) interface (e.g., card, device) 1018 and an input/output port 1010 that are controlled by at least an input/output (I/O) controller 1040. The disk 1006 may be, for example, a magnetic disk drive, a solid state disk drive, a floppy disk drive, a tape drive, a Zip drive, a flash memory card, a memory stick, and so on. Furthermore, the disk 1006 may be a CD-ROM drive, a CD-R drive, a CD-RW drive, a DVD ROM, and so on. The memory 1004 can store a process 1014 and/or a data 1016, for example. The disk 1006 and/or the memory 1004 can store an operating system that controls and allocates resources of the computer 1000.

The computer 1000 may interact with, control, and/or be controlled by input/output (I/O) devices via the input/output (I/O) controller 1040, the I/O interfaces 1018, and the input/output ports 1010. Input/output devices may include, for example, one or more displays 1070, printers 1072 (such as inkjet, laser, or 3D printers), audio output devices 1074 (such as speakers or headphones), text input devices 1080 (such as keyboards), cursor control devices 1082 for pointing and selection inputs (such as mice, trackballs, touch screens, joysticks, pointing sticks, electronic styluses, electronic pen tablets), audio input devices 1084 (such as microphones or external audio players), video input devices 1086 (such as video and still cameras, or external video players), image scanners 1088, video cards (not shown), disks 1006, network devices 1020, and so on. The input/output ports 1010 may include, for example, serial ports, parallel ports, and USB ports.

The computer 1000 can operate in a network environment and thus may be connected to the network devices 1020 via the I/O interfaces 1018, and/or the I/O ports 1010. Through the network devices 1020, the computer 1000 may interact with a network 1060. Through the network, the computer 1000 may be logically connected to remote computers 1065. Networks with which the computer 1000 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, the method comprising:
inputting, into a memory of a computing device, a plurality of dynamic functions that are configured to sequentially execute, each dynamic function of the plurality of dynamic functions being interdependent on at least one other dynamic function based on a plurality of calculation attributes;
wherein one or more of the dynamic functions have at least one or more calculation expressions and one or more conditional expressions, the calculation expressions and conditional expressions being dependent on one or more of the plurality of calculation attributes from other dynamic functions;
for a first set of input values, executing a first execution of the plurality of dynamic functions to generate a first final result, wherein the plurality of calculation attributes have a first set of calculation attribute values during run-time;
in response to a user, via a graphical user interface (GUI), changing at least one calculation attribute value from the first set of input values to a second value, re-executing the plurality of dynamic functions to generate a second final result in a second execution;
during the second execution, tracking the plurality of dynamic functions that were executed for generating the second final result and generating an execution path of functions that were executed during the second execution;
determining, from the functions that were executed, how one or more calculation expressions are calculated during the second execution and identifying a second set of calculation attribute values of the calculated expressions that occurred during the second execution;
identifying triggered conditional expressions which include conditional expressions from the dynamic functions that were triggered during the second execution, wherein the triggered conditional expressions are included in the execution path;
displaying visually, on the GUI, the execution path that visually shows a progression of how the changed calculation attribute caused subsequent changes in results at subsequently executed dynamic functions in the plurality of dynamic functions; and
generating and displaying, on the GUI, a summary of tracking results to visually identify attribute value changes between the first execution and the second execution, wherein the summary of tracking includes the first set of calculation attribute values that occurred during the first execution and the second set of calculation attribute values that occurred during the second execution.

2. The method of claim 1, wherein the tracking includes generating a sequence of execution from the functions that were executed during the second execution.

3. The method of claim 1, wherein displaying the execution path further comprises:
generating a simplified expression for one or more calculation expressions that were executed, wherein the simplified calculation expression includes data values inserted into the calculation expression; and
displaying the simplified expressions to visually identify how the calculation expression was calculated during the second execution run.

4. The method of claim 1, wherein the tracking includes identifying and displaying a change type for indicating what caused an associated change in value of a calculation attribute between the first execution run and the second execution run.

5. The method of claim 1, further comprising storing the one or more calculation attribute values that were involved in producing the first final result in the first set of calculation attribute values and displaying, via the GUI, the first set of calculation attribute values.

6. The method of claim 1, further comprising:
identifying and displaying one or more alerts triggered in the execution path caused by one or more changed calculation attribute values in the plurality of dynamic functions to determine conditions that led to different execution paths, unexpected results, or logical faults.

7. The method of claim 1, further comprising:
for a calculation attribute that changed in value in the second execution run, generating and displaying an execution trail link in the summary of tracking results;
wherein the trail link is configured to be selectable and upon selection, generates and displays execution trail details that show how the calculation attribute was calculated during execution.

8. A non-transitory computer-readable medium that includes stored thereon computer-executable instructions that when executed by at least a processor of a computer cause the computer to:
input, into a memory of the computer, a plurality of dynamic functions that are configured to execute sequentially, each dynamic function of the plurality of dynamic functions being interdependent on at least one other dynamic function based on a plurality of calculation attributes;
wherein one or more of the dynamic functions have at least one or more calculation expressions and one or more conditional expressions, the calculation expressions and the conditional expressions being dependent on one or more of the plurality of calculation attributes from other dynamic functions;
for a first set of input values, execute a first execution of the plurality of dynamic functions to generate a first final result, wherein the plurality of calculation attributes have a first set of calculation attribute values during run-time;
re-execute the plurality of dynamic functions to generate a second final result in a second execution after a change is made to a selected calculation attribute value or to one or more of the dynamic functions;
during the second execution, track the plurality of dynamic functions that were executed for generating the second final result and determine an execution path during the second execution;
determine, from the functions that were executed, how one or more calculation expressions are calculated during the second execution, and identify a second set of calculation attribute values of the calculated expressions that occurred during the second execution;
generate and display visually, on the GUI, the execution path that visually shows a sequence of executed dynamic functions and a summary of tracking results to visually identify attribute value changes between the first execution and the second execution.

9. The non-transitory computer-readable medium of claim 8, further comprising instructions that when executed by at least the processor cause the processor to:
identify triggered conditional expressions which include conditional expressions from the dynamic functions that were triggered during the second execution, wherein the triggered conditional expressions are included in the execution path; and
determine and display how the triggered conditional expressions are calculated during the second execution.

10. The non-transitory computer-readable medium of claim 8, further comprising instructions that when executed by at least the processor cause the processor to:
generate a simplified expression for one or more calculation expressions that were executed, wherein the simplified calculation expression includes data values inserted into the calculation expression; and
display the simplified expressions to visually identify how the calculation expression was calculated during the second execution run.

11. The non-transitory computer-readable medium of claim 8, further comprising instructions that when executed by at least the processor cause the processor to:
identify and display a change type for indicating what caused an associated change in value of a calculation attribute between the first execution run and the second execution run.

12. The non-transitory computer-readable medium of claim 8, further comprising instructions that when executed by at least the processor cause the processor to:
store the one or more calculation attribute values for obtaining the first final result in the first set of calculation attribute values and displaying, via the GUI, the first set of calculation attribute values.

13. The non-transitory computer-readable medium of claim 8, further comprising instructions that when executed by at least the processor cause the processor to:
identify and display one or more alerts triggered in the execution path caused by one or more changed calculation attribute values in the plurality of dynamic functions to determine conditions that led to different execution paths, unexpected results, or logical faults.

14. The non-transitory computer-readable medium of claim 8, further comprising instructions that when executed by at least the processor cause the processor to:
for a calculation attribute that changed in value in the second execution run, generate and display an execution trail link in the summary of tracking results;
wherein the trail link is configured to be selectable and upon selection, generates and displays execution trail details that show how the calculation attribute was calculated during execution.

15. A computing system, comprising:
at least one processor connected to at least one memory;
a non-transitory computer readable medium including instructions stored thereon that when executed by at least the processor cause the processor to:
input into the memory, a plurality of dynamic functions that are configured to execute sequentially, wherein one more dynamic functions of the plurality of dynamic functions are interdependent on one or more other dynamic functions based on a plurality of calculation attributes;
wherein one or more dynamic functions have at least one or more calculation expressions and one or more conditional expressions, wherein the calculation expressions and the conditional expressions are dependent on one or more of the plurality of calculation attributes from other dynamic functions;
for a first set of input values, execute a first execution of the plurality of dynamic functions to generate a first final result, wherein the plurality of calculation attributes have a first set of calculation attribute values during run-time;
re-execute the plurality of dynamic functions to generate a second final result in a second execution after a change is made to a selected calculation attribute value or after a change to one or more of the dynamic functions;
during the second execution, track the plurality of dynamic functions that were executed for generating the second final result and determine an execution path during the re-executing;
determine, from the functions that were executed, how one or more calculation expressions are calculated during the second execution, and identify a second set of calculation attribute values of the calculated expressions that occurred during the second execution; and
generate and display visually, on the GUI, the execution path that visually shows a sequence of executed dynamic functions and a summary of tracking results to visually identify attribute value changes between the first execution and the second execution.

16. The computing system of claim 15, wherein the instructions further include instructions that when executed by at least the processor cause the processor to:
identify triggered conditional expressions which include conditional expressions from the dynamic functions that were triggered during the second execution, wherein the triggered conditional expressions are included in the execution path; and
determine and display how the triggered conditional expressions are calculated during the second execution.

17. The computing system of claim 15, wherein the instructions further include instructions that when executed by at least the processor cause the processor to:
generate a simplified expression for one or more calculation expressions that were executed, wherein the simplified calculation expression includes data values inserted into the calculation expression; and
display the simplified expressions to visually identify how the calculation expression was calculated during the second execution run.

18. The computing system of claim 15, wherein the instructions further include instructions that when executed by at least the processor cause the processor to:
identify and display a change type for indicating what caused an associated change in value of a calculation attribute between the first execution run and the second execution run.

19. The computing system of claim 15, wherein the instructions further include instructions that when executed by at least the processor cause the processor to:
identify and display one or more alerts triggered in the execution path caused by one or more changed calculation attribute values in the plurality of dynamic functions to determine conditions that led to different execution paths, unexpected results, or logical faults.

20. The computing system of claim 15, wherein the instructions further include instructions that when executed by at least the processor cause the processor to:
for a calculation attribute that changed in value in the second execution run, generate and display an execution trail link in the summary of tracking results;
wherein the trail link is configured to be selectable and upon selection, generates and displays execution trail details that show how the calculation attribute was calculated during execution.
